(19) United States
(12) Patent Application Publication
(10) Pub. No.: US 2004/0098246 A1
(43) Pub. Date: May 20, 2004

(54) System and method for displaying documents in a language specified by a user

(76) Inventors: Donald J. Welch, Vancouver, WA (US); Heather Matthews, Camas, WA (US); Mark Schmidt, Camas, WA (US)

Correspondence Address: HEWLETT-PACKARD COMPANY, Intellectual Property Administration, P.O. Box 272400, Fort Collins, CO, 80527-2400, US

(21) Appl. No.: 10/299,134

(22) Filed: Nov. 19, 2002

(51) Int. Cl. G06F 17/28

(52) U.S. Cl. 704/3

(57) ABSTRACT

A method of displaying a requested document is described. The method may include pre-formatting the document with special tags that correspond to information to be imported from one of plural files, each file containing information in a predefined language, identifying one of the predefined languages that the document is to be displayed, replacing the special tags with corresponding information from one of the files that is associated with the identified language and displaying the document with the information representing the identified language.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

When a product is sold to a customer, it is customarily accompanied with documentation for the product. This product documentation generally contains information regarding proper installation and maintenance of a product as well as instructions on how to efficiently use the product, etc.

However, if the product documentation is to be useful to each user, each user must be able to read the documentation. Hence, it is desirable to have the product documentation written in the language that is native to where the product is being sold. Consequently, if a company sells a product in twenty different countries, each having a different language, it is desirable for the company to have twenty different versions of the product documentation, each written in the corresponding language. Maintaining these different versions of documents, as well as distributing them, can present problems.

### SUMMARY OF THE INVENTION

The present invention includes as one embodiment a method of displaying a requested document including pre-formatting the document with special tags that correspond to information to be imported from one of plural files, each file containing information in a predefined language, identifying one of the predefined languages that the document is to be displayed, replacing the special tags with corresponding information from one of the files that is associated with the identified language and displaying the document with the information representing the identified language.

### BRIEF DESCRIPTION OF THE DRAWINGS

The present invention can be further understood by reference to the following description and attached drawings that illustrate the preferred embodiments. Other features and advantages will be apparent from the following detailed description of the preferred embodiment, taken in conjunction with the accompanying drawings, which illustrate, by way of example, the principles of the invention.

FIG. 1 is an overview block diagram showing one embodiment of the present invention.

FIG. 2 is a sample list of languages, codes and character sets that are used in one embodiment of the present invention.

FIG. 3 is a flow chart of a process that is used in one embodiment of the present invention when parsing a document at release time.

FIG. 4 is a flow chart of a process that is used when parsing a document at runtime in one embodiment of the present invention.

### DETAILED DESCRIPTION

I. Description of Components and Operation:

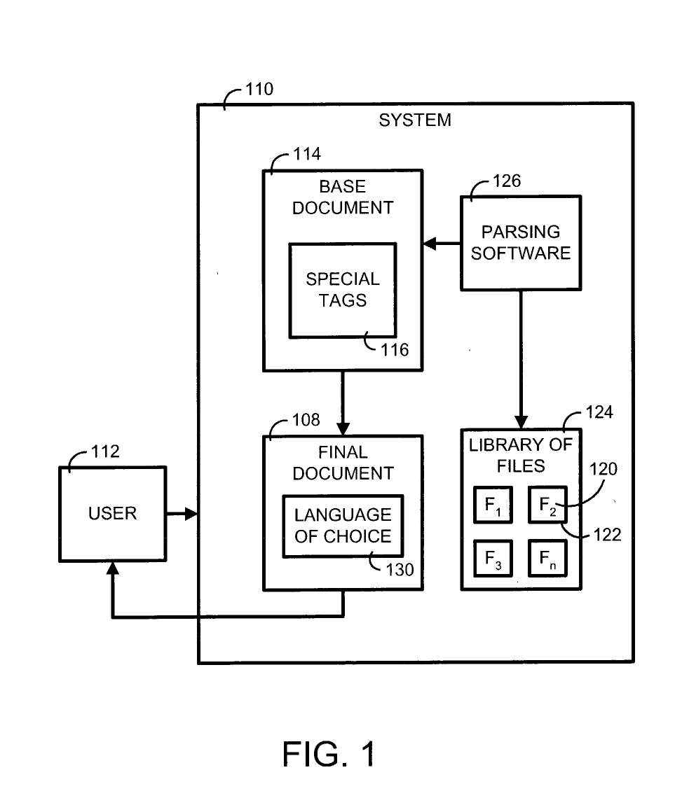

FIG. 1 is an overview block diagram showing one embodiment of the present invention. The present embodiment relates to dynamic generation of a final document 108, derived from a base document 114, in a written language designated by a user 112. The documents 114 and 108 may be created in any suitable markup programming language, such as HTML (Hypertext Markup Language), XML (Extensible Markup Language), SGML (Standard Generalized Markup Language), etc., with special tags 116. The special tags 116 are used to instruct where and how strings of text 120 from archived files 122 (F₁-F_{N}) are to be placed in the base document 114. As indicated, the archived files 122 (F₁-F_{N}) may be located in a library of files 124.

The strings of text 120 located in the archived files 122 (F₁-F_{N}) can be any type of information that is desired to be inserted into the final document 108. For example, in one embodiment, the strings of text 120 correspond to text and characters representing paragraphs of information in different languages. This allows the final document 108 to be dynamically generated in a language corresponding to the strings of text 120 (F₁-F_{N}) that are inserted into the final document 108.

A parsing software program 126 is used to locate the special tags 116 in the base document 114 and to import the strings of text 120 into the base document 114. The base document 114 with special tags 116, the archived files 122 (F₁-F_{N}) and the parsing program 126 may all be stored on a portable medium (e.g., a CD-ROM). The portable medium may be given to a user and later read by use of a stand-alone computer.

The dynamic generation of the final document 108 is initiated when the user 112 inputs a request to view the final document 108 in a particular language 130. In response to the request, the system 110 instructs the parser program 126 to parse the base document 114 to find the special tags 116 that are associated with the user specified language 130. The strings of text 120 associated with the specified language is located and imported from the archived files 122 (F₁-F_{N}) and appropriately placed in the base document 114 according to the rules and instructions of the special tags 116 so as to generate the final document 108.

The base document 114 with special tags 116, the archived files 122 (F₁F_{N}) and the parsing program 126 may be completely, or in part, placed on a server and/or client in a client-server environment. In this environment, when a user on the client wants to access a final document, the server may import all pertinent strings of texts associated with the user specified language into the base document before the final document is downloaded to a browser on the client for viewing by the client user.

II. Working Example:

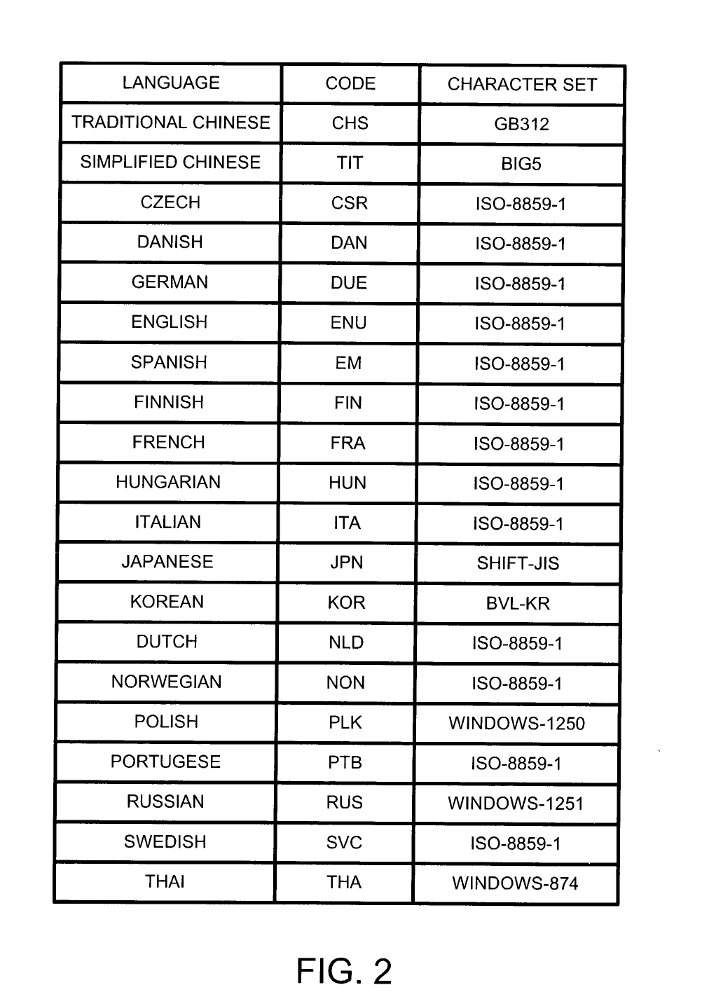

The below description describes a working example of one embodiment of the present invention and is presented for illustrative purposes. Referring to FIG. 1 along with FIG. 2, in one embodiment, HTML markup language is used to create the base document 114 with special tags 116. A sample of raw source code of an HTML file that may be used, in this example, is shown below:

[ $HCP ]
<html>

<head>

<title> [$] WriteString ( ″printer_assistant_name″ ) [/$] </title>

</head>
<body bgcolor = ″#FFFFFF″>

<p> [$] WriteComposite ( ″sample.welcome_msg″ , ″<I>″ , ″</I>″) [/$] </p>
<p> [$] WriteString ( ″sample.disc″ ) [/$] </p>
<p> [$] WriteComposite ( ″sample.hp_link″ , ″ <a href= ″ , ″ > ″ ) [/$] </a>

</p>

</body>

</html>

The base documents 114 (e.g., product documentation) may contain a plurality of pages or files with the above source code. As shown above, the source code is similar to standard HTML code, except for two additional tags. In this embodiment, additional tags include an opening meta-tag “[$HCP]” and special opening tags “[$]” and closing tags “[/$].”

According to the present invention, when a user wants to display the product documentation in an HTML capable browser, the parser 126 is automatically invoked to parse the base document 114 for the special tags 116 before sending the final document 108 to the user 112 to be displayed. Between each opening and closing pair of special tags 116 is a function. In one embodiment, the function is written in JavaScript and will be explained later in greater detail. Once a pair of special tags 116 is encountered, the function contained therein is extracted and sent to a JavaScript engine for processing. The output of the JavaScript engine is used to replace both the pair of special tags 116 and the function contained therein. An XML based merge and format program or XSLT style sheets or the like can be used to merge the output with the base document 114 to produce the final document 108. Alternatively, any suitable merging program can be used to merge the output with the base document 114.

Note that JavaScript is used, in this example, for standardization, extensibility (i.e., to allow Java functions to be easily added in the file) and ease of use (i.e., Java as an interpreted language is easier to use than a compiled language) purposes. Thus, it should be understood that any other computer language could have been used in alternative embodiments.

For backward compatibility and for maximum performance, not all HTML files are necessarily parsed. In this embodiment, all of the files that are to be parsed contain an opening meta-tag (for example, the “[$HCP ]” shown in the above sample source code) near or at the first line of source code. By contrast, all files that should not be parsed are devoid of this opening meta-tag. Thus, the opening meta-tag is used to instruct the parser to parse the file in which it is found.

In one embodiment, there are plural functions used within the special tags. In one embodiment, some sample functions include searching for strings, identifying strings, finding strings and replacing strings with other variables in the library of files. For instance, some of these functions include WriteString, GetString, WriteMacro, GetMacro and WriteComposite.

In this embodiment, the WriteString function finds strings with pre-identified values in the library of files, which can be an XML file library. The WriteString function then writes the results to the base document 114 in place of the associated special tags. In other words, it replaces the function and special tags of the HTML file with the found result. The GetString function finds strings with identified values in the library of files without writing the value into the destination file. The WriteMacro function writes a macro with pre-identified values into the base document 114 in place of the associated special tags. The WriteComposite function finds and retrieves strings with pre-identified values in the library of files (in this case, the XML file library) and replaces certain special tags with specified insertion strings.

For example, if a raw HTML file contains the following line:

[$]WriteComposite (“test”,“<br>”)[/$]

where [$] and [/$] are the pair of special tags, WriteComposite is the function, test is the name of a string in an XML file (i.e., the string with the identified values) and <br> is a special formatting tag. Further, if the string in the XML file is:

<test>Hello[!!!]World</test>

then, the line in the raw HTML file will be replaced as follows:

Hello<br>World

As mentioned above, the functions WriteString, GetString and WriteComposite perform a string lookup using an XML file as a source. The XML file is in a library. The library is arranged by language using the element “lang” with an attribute “id”. The attribute “id” specifies the language in which the strings in an XML file are written. Each language has a specific “id” or code (see FIG. 2). For example, the language “id” or code for English is “enu” and the character set is ISO-8859-1.

When a user enters English as the written language of choice 130 in which a document is to be presented, then, the code enu is entered into a registry that is accessible to the JavaScript engine. Thus, when a function is being processed (i.e., GetString, WriteString or WriteComposite), the registry is consulted for the language id or code. Using the code, the correct XML file in the library of files 124 is accessed to obtain the string.

A sample of raw source code of an XML file that may be used by the present invention is shown below:

<lang id = ″enu″ charset = ″iso-8859-1″ >

<printer_assistant_name> hp printer assistant

</printer_assistant_name>

<sample.welcome_msg> Welcome to the [!!!] for hp printers

</sample.welcome_msg>

<sample.disc> This program helps you with your printer.

</sample.disc>

<sample.hp_link> Visit [!!!] ″http://www.hp.com″ [!!!]

</sample.hp_link>

</lang>

In this case, a DTD (document type definition) or schema is not used. A DTD defines what tags and attributes are used to describe contents in an XML document, where each tag is allowed, and which tags can appear within other tags. A schema, on the other hand, can be viewed as a collection (vocabulary) of type definitions and element declarations whose names belong to a particular namespace called a target namespace. Target namespaces enable a user to distinguish between definitions and declarations from different vocabularies. For example, target namespaces would enable a user to distinguish between the declaration of an element in the XML Schema language vocabulary, and a declaration of an element in a hypothetical language vocabulary.

The first line of the sample XML source code above contains the language id as well as a character set (i.e., ISO-8859-1) used by the language. The second line contains element “printer_assistant_name” and string “hp printer assistant”. Likewise, each of the other lines contains an element and a corresponding string.

The document may be parsed at release time (i.e. when the product is being released to the public or more particularly to a specific market) or at runtime (i.e., when a user is accessing the document). It should be noted that parsing the document at release time usually results in faster runtime performance.

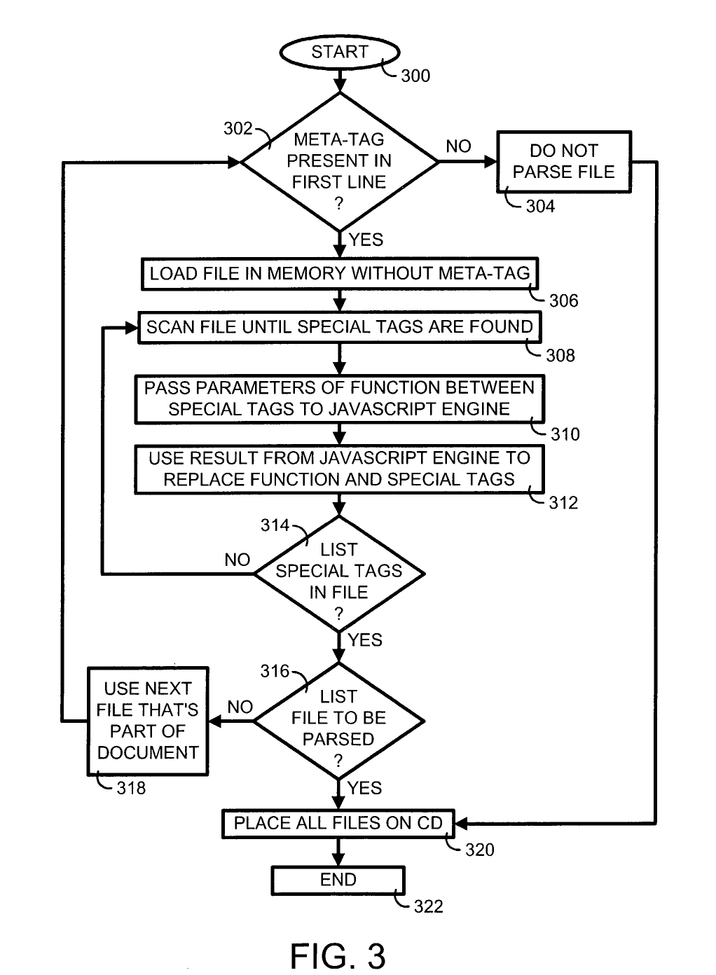

FIG. 3 is a flow chart of a process that is used in one embodiment of the present invention when parsing a document at release time. Referring to FIG. 1 along with FIG. 3, in one embodiment, all language and product dependent files are stored into a directory (i.e., an archive directory) before the document is parsed. The process starts when the parser is invoked (step 300). Once invoked, the parser checks each file in the directory that makes up the base document 114 for the opening meta-tag to determine whether or not the file is to be parsed (step 302). Sample opening meta-tags include a [$HCP] and a [#HCP] opening met-tag. If not, the file is not parsed (step 304).

If so and if the document is to be parsed at release time, the parser will check the files for a predefined opening meta-tag, such as the [$HCP] meta-tag. If on the other hand, the document is to be parsed at runtime, the files will be checked for another predefined opening meta-tag, such as the [#HCP] meta-tag. The opening meta-tag can have predefined characters that are later used in the special tags 116. For example, if the opening meta-tag is [$HCP], then the special tags would use [$] . . . [/$] as open and close tags. If, on the other hand, the opening meta-tag is [#HCP] in lieu of [$HCP], the special tags would use [#] . . . [/#] as open and close tags.

If the base document 114 is parsed at release time, the parser 126 will scan each page or file associated with the base document 114 for the opening meta-tag. If a page or file contains the opening meta-tag, the page or file will be loaded into memory with the meta-tag removed (step 306). Then, the page or file is recursively scanned for the special tags 116 (step 308).

The parameters of the function between the special tags 116 are passed to a function-processing engine, such as a JavaScript engine. The function-processing engine processes and extracts pertinent data, instructions and parameters from the special tags 116 to produce results (step 312). It should be noted, as discussed above, that the function-processing engine can be implemented in any suitable programming language such as C, C++, Java and the like. The respective results produced by the function-processing engine replace the respective processed special tags 116 (step 314). The process can then list special tags in the page or file, list the pages or files to be parsed or use the next file that's part of the base document 114 and then place all of the files on a portable readable medium, such as a CD-ROM (steps 316-324).

In one embodiment of the present invention, a JavaScript engine is used with XML files in the library of files 124. In this embodiment, the process includes using a GetString, WriteString, GetMacro, WriteMacro and WriteComposite functions. These functions are for performing operations as described above to find and place the correct replacements for the special tags 116 in the base document 114.

For example, in this embodiment, if a page or file of the base document 114 is to be parsed so that the written language rendered is English, the first function that will be encountered by the parser 126 is the WriteString function with references to a library of files 124 containing English strings of text 120. Upon encountering this function, the parser 126 invokes the JavaScript engine, which processes the function. Basically, using the code for the language, as shown in FIG. 3, the English version of the XML file is accessed from the library of files 124.

A parameter of the function associated with text or a functional instruction string between the XML element that coincides with the parameter of the function is found. The found text or functional instruction string is then used to replace the associated special tags 116 in the base document 114. The parser 126 then passes an instruction to reset the special tags to the JavaScript Engine. After the entire page or file has been parsed and all of the text or functions associated with each special tag are found and inserted into the base document 114, it will be transformed into source code without the opening tag or the special tags 126. For example, see the below sample source:

<html>

<head>

<title> hp printer assistant </title>

</head>
<body bgcolor = ″#FFFFFF″>

<p> Welcome to the <i> hp printer assistant </i> for hp printers </p>
<p> This program helps you with your printer </p>
<p> Visit <a href= ″http://www.hp.com″> http://www.hp.com </a>

</p>

</body>

</html>

As can be seen, all of the special tags 126 are replaced by text or functions by the JavaScript engine from the library of files 124 using their respective associated special tags.

In one embodiment, once all of the pages or files of the base document 114 have been parsed, the files can be stored on portable medium, such as a CD-ROM or a server for Internet access by a Web browser. If a CD-ROM is used, the CD-ROM can be physically given to the user.

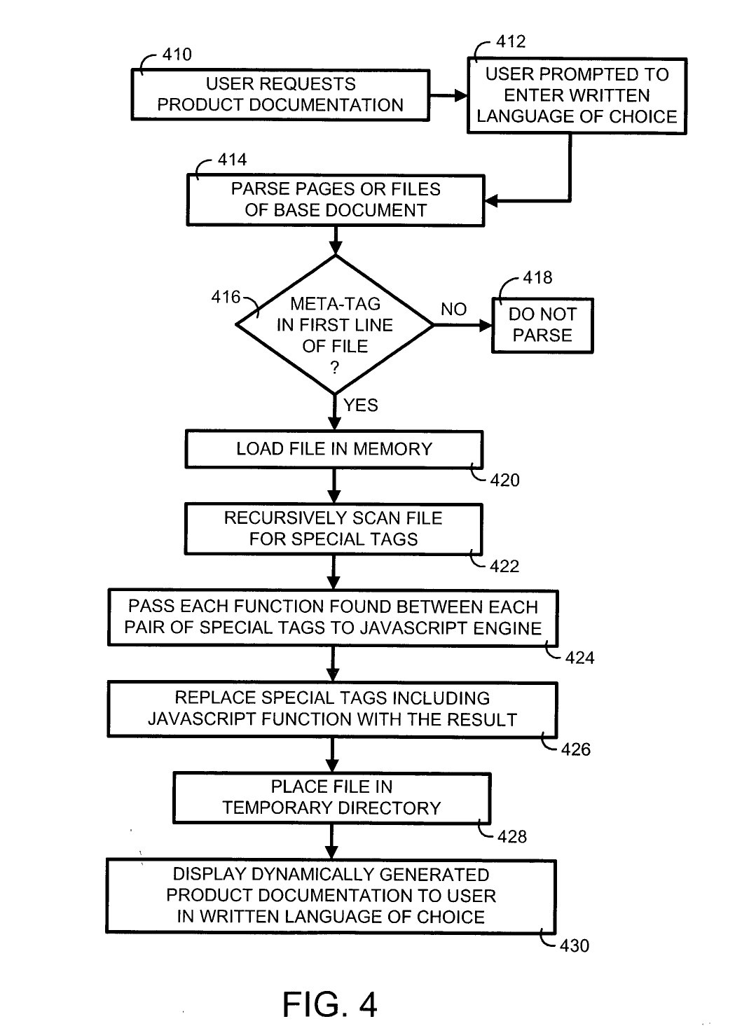

FIG. 4 is a flow chart of a process that is used when parsing a document at runtime in one embodiment of the present invention. Referring to FIG. 1 along with FIG. 4, in this embodiment, all of the files that make up a document as well as the parser 126, the function-processing engine, the library of files 124, etc. are all stored on a CD-ROM that is given to a purchasing customer/user. When the user makes a request to access the product documentation (step 410), the user is first prompted to enter the written language of choice 130 (step 412).

Next, the parser 126 is invoked to parse a raw HTML file that is associated with the product documentation that was requested by the user (step 414). The parser 126 fetches the pages or files associated with the product documentation requested by the user and checks to determine whether the pages or files contain the opening meta-tag (step 416). In one embodiment, the opening meta-tag is [#HCP], since the file is being parsed at runtime.

If the opening meta-tag is not present, the page or file will not be parsed and will be sent to the browser for display (step 418). If, on the other hand, the opening meta-tag exists, the parser 126 will load the file in memory and then remove the opening meta-tag (step 420). The parser 126 then recursively scans the page or file for the special tags having open and close tags corresponding to the character used in opening tag ([#] . . . [/#]) (step 422).

As mentioned above, each pair of special tags include parameters associated with text or instructional functions. The parameters along with the code for the written language entered by the user are parsed and passed by the parser 126 to the function-processing engine (step 424). The function-processing engine accordingly processes the page or file.

The code of the written language designated by the user is used (see FIG. 3) to access a proper XML file from the library of files 124 to obtain the results determined by the special tags 116. The respective results are used to replace the respective corresponding special tags in the page or files of the base document 114 (step 426). After all of the special tags in the pages or files have been replaced with the appropriate results, the pages or files may be placed in a temporary directory (step 428) in order to be displayed to the user as the dynamically generated final product documentation 108 (step 430). The documentation 108 is displayed in the language 130 selected by the user at step 412.

III. Conclusion

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the present invention as defined by the following claims.

What is claimed is:

1. A method of displaying a requested document comprising:
pre-formatting the document with special tags that correspond to information to be imported from one of plural files, each file containing information in a different predefined language;
identifying one of the predefined languages that the document is to be displayed;
replacing the special tags with corresponding information from one of the files that is associated with the identified language; and
displaying the document with the information representing the identified language.

2. The method of claim 1 wherein the special tags are replaced by strings of text in the identified language.

3. The method of claim 2 wherein the document and a library of files associated with the special tags are local to a computer on which the document is to be displayed.

4. The method of claim 3 wherein each special tag has an associated function;
wherein each associated function includes identifying particular strings of text that are to be imported into the document.

5. The method of claim 4 wherein the files in the library of files are Extensible Markup Language (XML) files.

6. The method of claim 5 wherein a document type definition and schema are not used for the Extensible Markup Language (XML) files.

7. The method of claim 6 wherein the language is identified based upon user input.

8. The method of claim 1 wherein the special tags contain predefined instructional functions and commands.

9. A computer program product on a computer readable medium for displaying a document with preformatted special tags, comprising:
program code that identifies a language in which the document is to be displayed, replaces the special tags with corresponding information from a file that is associated with the identified language and displays the document with the corresponding information.

10. The computer program product of claim 9, wherein the special tags indicate strings of text to be imported from a file in a library of files, the library of files containing at least one file for each of a plurality of different languages.

11. The computer program product of claim 10, wherein the special tags contain instructional functions and commands.

12. The computer program product of claim 9, wherein the document and the program code reside on a portable storage medium.

13. The computer program product of claim 9, wherein the document and the program code reside on a server that is accessible by an Internet website browser.

14. The computer program product of claim 9, wherein each special tag identifies strings of text to be imported into the document.

15. The computer program product of claim 10, wherein the files in the library of files are XML files.

16. The computer program product of claim 15, wherein a document type definition and schema are not used for the XML files.

17. The computer program product of claim 9, wherein the computer readable medium is a portable storage medium and wherein the document is also stored on the portable storage medium.

18. An apparatus for displaying a document comprising:
means for pre-formatting the document with special tags that correspond to information to be imported from one of plural files, each file containing information in a different predefined language;
means for identifying one of the predefined languages that the document is to be displayed;
means for replacing the special tags with corresponding information from the files that contains information in the identified language so as to create a final document; and
means for displaying the final document.

19. The apparatus of claim 18, wherein the special tags are replaced by strings of text in the identified language.

20. The apparatus of claim 18, wherein the document and a library of files associated with the special tags are local to a computer on which the document is to be displayed.

21. The apparatus of claim 18, wherein each special tag has an associated function and each associated function includes identifying particular strings of text that are to be imported into the document.

22. The apparatus of claim 20, wherein the files in the library of files are XML files.

23. The apparatus of claim 18, further comprising means for identifying that the document includes an opening meta-tag and means for parsing if it has the opening meta-tags.

24. A method of displaying a document in a particular language, where the document includes special tags, the method comprising:
receiving input from a user that identifies a particular language that the document is to be displayed;
replacing the special tags with corresponding information that is associated with the identified language; and
displaying the document with the information representing the language identified by the user.

25. The method of claim 24 wherein the special tags are replaced by strings of text in the identified language.

26. The method of claim 24 wherein the document and a library of files associated with the special tags are local to a computer on which the document is to be displayed.

27. The method of claim 26 wherein each special tag has an associated function, wherein each associated function includes identifying particular strings of text that are to be imported into the document.
